(19) United States
(12) Patent Application Publication
(10) Pub. No.: US 2005/0056514 A1
(43) Pub. Date: Mar. 17, 2005

(54) Clutch actuation system for a starting clutch in a motor vehicle

(76) Inventor: Matthias Reisch, Ravensburg (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/939,076

(22) Filed: Sep. 10, 2004

(30) Foreign Application Priority Data
Sep. 17, 2003 (DE) 103 42 896.8

(51) Int. Cl. F16D 25/0638

(52) U.S. Cl. 192/85 AA; 192/106 F

(57) ABSTRACT

The invention concerns a clutch actuation system for a starting clutch (1) of a motor vehicle, with a hydraulic activated piston/cylinder combination (2), which possesses a pressure chamber (5) and a slidable activation piston (4) therein, with a pressure compensation compartment (6) for a dynamic pressure equalization, and which said pressure compensation compartment (6) can be filled with a fluid pressure medium, which, upon a rotation of the piston/cylinder combination (2) exercises a force which counters movement in a closure direction by the activation piston, and has a reset spring (7), which abuts against an inner wall of the pressure compensation compartment (6) and forcefully contacts a proximal surface of the activation piston (4). In order that, in the case of a motor vehicle with such a clutch activation system, when a failure of the control apparatus which governs the activation of the starting clutch (1) causes the necessity of emergency driving, provision is made, that the pressure compensation compartment (6), for the carrying out of the emergency driving, is filled only to the extent, that following a predetermined speed of rotation, the pressure medium resident in the pressure chamber (5) can slidingly displace the activation piston (4) alone, with the aid of centrifugal force acting against the oppositely directed force of the reset spring (7) and against the resident pressure medium in the pressure compensation compartment (6), to the extent that the clutch (1) closes.

The invention concerns a clutch activation system for a starting clutch in a motor vehicle, in accord with the principal concept of patent claim 1.

There are many examples for the arrangement of clutches and their activation apparatuses in motor vehicles. In this regard, the yet unpublished DE 102 48 172 discloses an automatic transmission with a multi-disc clutch, which possesses a servo device in the form of a piston-cylinder combination, which is set radially within a disk carrier and allows dynamic pressure compensation. Furthermore, a planetary gear set is a component of this automatic transmission.

The servo device of this transmission consists of an activation piston, which, together with a correspondingly designed wall of the disk carrier, creates a pressure chamber. This said chamber can be subjected to pressure by the entry of a pressure medium through an inlet boring penetrating the disk space. When pressure is applied and after overcoming a resisting force from an opposing spring, an axial, sliding movement of the piston occurs against the clutch disks.

On that side of the piston, which is remote from the pressure chamber, is a pressure compensation compartment containing the hydraulic medium, for equalizing the dynamic pressure on the activation piston, which pressure is generated as a result of clutch rotation.

Such stepwise automatic transmissions can be combined with starting elements for installation in motor vehicles. The starting elements, for example, typically incorporate hydrodynamic torque converters or hydraulically activated starting clutches.

In an operational failure of the electronic control system for ratio-changing procedures in a conventional stepwise, automatic transmission, correction thereof is brought about with a torque converter by means of adjusting a gear train ratio through a hydraulic emergency control. Such an emergency measure would permit driving the motor vehicle at least to the nearest repair garage.

Conversely, when vehicles are concerned, in which a transmission equipped with a hydraulically activated starting clutch is installed, the described emergency driving concept is much more difficult to realize, because, in such a situation, renewed starting is scarcely possible.

On account of the given background, the purpose of the invention is to make available a clutch activation system for a starting clutch of a motor vehicle, wherein, even in the described emergency situation, and following an operational loss of the control equipment, a starting of the vehicle and in addition, a continued travel of the same to the nearest point of repair is possible.

The achievement of this purpose is available for the clutch activation system in the features of the principal claim, while advantageous designs and improvements are evident in the subordinate claims.

The invention presupposes the recognition, that a hydraulically energized, starting clutch, even in a case of failure of the electronic control of clutch activation, has the ability to permit reactivation of said clutch, by exercising an active influence on the amount of hydraulic fluid residing in the pressure compensation compartment.

In accord with this, the invention concerns itself with a clutch activation system for the starting clutch of a motor vehicle, wherein said vehicle possesses a hydraulically activated piston/cylinder combination, which is characterized by a cylinder, within which is to be found an axially displaceable activation piston. A further feature of the piston/cylinder combination is a pressure compensation compartment, for a dynamic balancing of pressure. The pressure compensation compartment is designed to be filled with a fluid pressure medium. This pressure medium, upon a rotation of the piston/cylinder combination, exercises force upon the activation piston, which force is directed counter to the closing direction of the activation piston. Additionally, a reset spring is present, which spring abuts against an inner wall of the pressure compensation compartment and acts upon that surface of the activation piston, which is proximal to the compensation compartment.

For achieving the stated purpose, provision has also been made, that the pressure compensation compartment be only filled to such an extent, that the execution of an emergency vehicle run is enabled, and further, in excess of a predetermined threshold speed of rotation of the piston/cylinder combination, the pressure medium residing in the pressure compensation compartment, counter to the opposing force of the reset spring and aided by centrifugal force, does push the activation piston into the pressure compensation compartment so far, that the clutch closes.

Because of this construction, it becomes possible that in normal driving operation, with a functioning control system, the pressure compensation compartment can be filled with hydraulic fluid for the carrying out of normal dynamic pressure compensation. Upon failure of the control system, this pressure compensation function, at least to a great extent, is no longer in operation.

Advantageously, after a stillstand of the vehicle as well as the driving motor, the starting clutch can be activated to initiate a restarting procedure as well as enable emergency travel. In this restart procedure, the activation is such, that driven by the transmission input shaft, the cylinder of the clutch activation system is brought to such a speed of rotation, that the hydraulic pressure medium found in a pressure chamber, due to centrifugal force, acts upon the piston, which, without or with only a small counter pressure, is displaced from the pressure compensation compartment in the closure direction so far against the clutch, that the same closes.

For the carrying out of the invented function, provision is made in a development of the invention, in that the degree of filling of the pressure compensation compartment with pressure medium is adjustable by means of a controlling flow device.

The controlled device can encompass, at least one regulated valve, which, in normal driving, can be positioned by the controller of the activation piston and/or the controller of the filling level of the pressure compensation compartment. However, in a case of control failure, the filling of the pressure compensation compartment does not take place.

The inlet, or feed mechanism, for the pressure chamber and for the pressure compensation compartment include, essentially, flow paths for the hydraulic pressure medium, including, at least, the one mentioned above and in these flow paths are installed regulated valves, a reservoir space for the hydraulic medium as well as a pressure pump.

For the emptying of the pressure compensation compartment, an outlet port is provided therein, which, in an advantageous manner, is designed as a pressure aperture and is located to advantage in the area of the radial, outer end of the pressure compensation compartment. Associated with this said aperture, can be an installed regulated valve.

In accord with the invention, for the purpose of achieving an axially short construction of the piston/cylinder there is an added provision, that at least one wall of the pressure compensation compartment is formed by that side of the piston, which is remote from the pressure chamber.

First, the restoration force of the reset spring and second, the existing filling level of the pressure compensation compartment, in a case of control failure, are advantageously so preselected, that the speed of rotation at a starting effort and the speed of rotation of the input drive shaft during the successive emergency driving, are sufficient, even when the pressure chamber of the piston/cylinder combination is no longer pressurized, to alone close the clutch and keep it closed by use of the centrifugal pressure acting upon the piston by the pressure medium which remains in the pressure chamber.

The invented clutch activation system is used for the activation of the starting clutch, and said system is designed as a multi-disc clutch and is part of an automatic transmission.

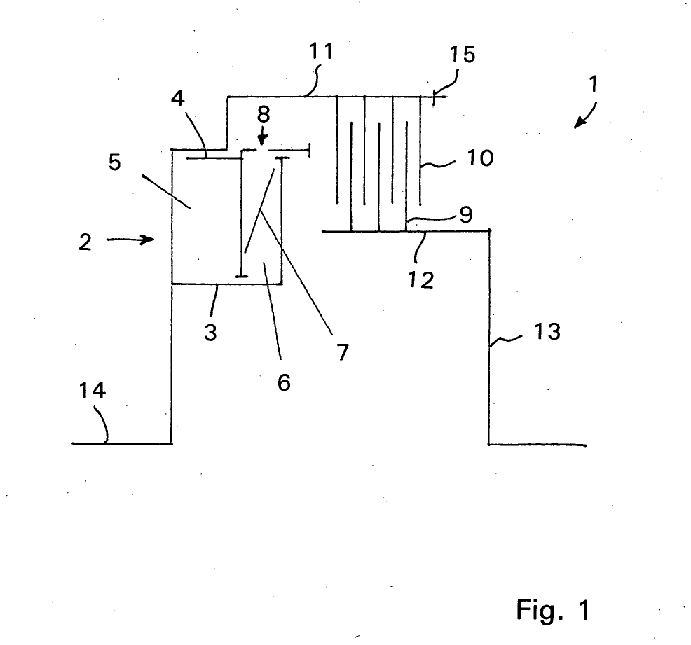

To improve the clarity of an explanation of the invention, FIG. 1 is attached to amplify the description. The Figure shows, in a very schematic manner, a section of a stepwise, automatic transmission. As can be seen in FIG. 1 essentially is a starting clutch 1 designed as a multi-disc clutch and a piston/cylinder combination 2 for the activation of the clutch 1.

In regard to the transmission, this is an automatic transmission without a hydrodynamic torque converter. Lacking this, the input shaft 14 of the present transmission is directly, or indirectly connected to the outer disk carrier 11 of the starting clutch 1. A part of the outer disk carrier 11 forms walls of the cylinder 3 of the piston/cylinder combination 2 or is at least bound to said combination 2 in a mutually, rotationally fixed manner.

Within the cylinder 3 is an activation piston 4, which can be slidingly displaced in the axial direction. In this way, between the piston 4 and the walls of the cylinder 3, a pressure chamber 5 is formed. This pressure chamber 5 can be filled with a fluid pressure medium.

In order to subject the piston 4 to pressure, the fluid pressure medium flows through a controlled valve and through a feed opening into the pressure chamber 5 and, with reference to the attached FIG. 1, pushes the piston 4 to the right. Upon such movement, the piston presses against the disk packet of the starting clutch 1, comprised of inner disks 9 and outer disks 10. This combined movement stops when a detent 15 abuts its counter piece. With this arrangement, the torque brought to bear on the outer disk carrier 11, in a known way, is transmitted to the inner disk carrier 12 which bears the inner disks 9, which said disk carrier 12 itself is, in drive technology, bound with the other transmission shaft 13. For the opening of the clutch 1 a reset spring 7 exists, which, at the ending of the main pressurizing of the pressure chamber 5, pushes the piston 4 axially to a point at least partially in the direction of opening.

In addition, the clutch activation arrangement possesses a pressure compensation compartment 6, which is formed between, first, that side of the piston 4 which is remote from the activation cylinder 3 of the pressure chamber 5 and second, transmission elements which are not defined here in greater detail.

This pressure compensation compartment 6 can be filled with fluid pressure medium by means of a (not shown) on-off valve and an (again not shown) inlet opening, which medium, in the simplest case, is that same hydraulic pressure medium, which is also made use of as supply for the pressure chamber 5.

Moreover, in one of the walls which enclose the pressure compensation compartment 6, an outlet opening 8 is available for the fluid pressure medium. This opening 8 is designed as a pressure aperture through the radial outer end of the pressure compensation compartment 6. In, or attached to this opening 8, a valve can be installed. The pressure medium which exits out of the outlet opening 8 is conducted to a (not shown) flow path to other transmission components.

The operational sequence of the above described arrangement is as follows:

In an undisturbed operation of the transmission, a control apparatus issues, upon the receipt of, for example, a command from a vehicle driver, in the form of a signalized intent to start, to open the regulated valve, so that the hydraulic pressure medium flows into the pressure chamber 5 of the cylinder 3 under a controllable main pressure. In response, the piston 4 displaces itself into the closed position, whereby the starting clutch 1 is closed.

Next, the pressure compensation compartment 6 is filled with the fluid pressure medium, so that this, subsequently, in a known manner and at typical starting rotational speeds, supplies an activation compensated pressure, based on centrifugal force, to the piston 4.

If the starting clutch 1 should be open, then, the valve, from a signal from the control apparatus is brought into a switched condition, wherein the pressure chamber 5, for example, is subjected to only a so-called prefill pressure, which is less than that of the full pressure.

The thereby released opening movement of the piston 4 is driven by the reset spring 7, or at least supported thereby. The spring is so placed in the pressure compensation compartment 6, that the said spring exercises an axial replacement force on the piston 4.

Should it be, that the control apparatus, at the time of operational start of the vehicle, is defective, then the regulated valve cannot be set in such a position, in which the pressure chamber is subjected to the full pressure. On this account, the starting clutch 1 is, at first, not closed.

In addition to the above, in a defective state of the control, the input line of pressure medium to the pressure compensation compartment 6 remains closed, because the same, or a separate valve complementary thereto, cannot be activated.

In the case of a following attempt at placing the vehicle in operation, the motor thereof is started and thereby the transmission input shaft 14 is set into rotation. The therewith accompanying turning action of the piston/cylinder combination 2 relies then on centrifugal force acting upon the pressure medium residing in the pressure chamber 5. This said pressure medium now acts upon the piston 4 after a certain speed of rotation is achieved, resulting in the clutch disks 9, 10, being moved in a closing direction.

Since the pressure compensation compartment 6, now having a defective control apparatus, is not filled with pressure medium, or only slightly filled, no dynamic pressure compensation, or very little, is carried out. If necessary, the amount of pressure medium still to be found in the pressure compensation compartment 6 exits at this time through the outlet opening 8, which has been designed as a pressure aperture, and is conducted through a not-described fluid pathway to other components of the transmission.

As soon as the pressure compensation compartment 6 has been emptied to a certain point, then the force of the reset spring 7 can act on the piston 4 in the opening direction. Since the force of the spring 7 is designed to be comparatively weak, it manages to apply to the piston 4, which must be driven through the pressure medium remaining in the pressure chamber 5, sufficient force to act against clutch disks 9, 10, so that the starting clutch 1 is closed at least enough for emergency driving. Obviously, sufficient cooling at hand for the multi-disc clutch for the emergency driving.

Reference Numerals

1 starting clutch
2 piston/cylinder combination
3 cylinder of the piston/cylinder combination
4 activation piston
5 pressure chamber
6 pressure compensation compartment
7 reset spring
8 pressure aperture with exit opening and valve
9 inner disks of multi-disc clutch
10 outer disks of multi-disc clutch
11 outer disk carrier
12 inner disk carrier
13 main output transmission shaft
14 input shaft of transmission
15 detent for the multi-disc clutch

1-7. (CANCELED)

8. A clutch activation system for a starting clutch (1) in a motor vehicle, to which a hydraulically activated piston/cylinder combination (2) belongs, which encompasses a pressure chamber (5) containing an axially, slidingly displaceable activation piston (4), and having a pressure compensation compartment (6) for equalization of dynamic pressure and which can be filled with a pressure medium, and which, upon rotation of the piston/cylinder combination (2) exercises a force upon the activation piston (4), the force being counter to a closure-direction of the activation piston (4), and having a reset spring (7), which abuts on an inner wall of the pressure compensation compartment (6) and exercises force against a surface of the activation piston (4), the surface being proximal to the pressure compensation compartment (6), the pressure compensation compartment (6), when executing an emergency driving operation, is filled only to such a level with the pressure medium, that, from a predetermined speed of rotation, the pressure medium resident in the pressure chamber (5) of the piston/cylinder combination (2) can, alone, slidingly displace the activation piston (4) to such a distance in the closure direction, that the starting clutch (1) closes, and does so by centrifugal force acting counter to a force of the reset spring (7) as well as counter to the pressure of the pressure medium resident in the pressure compensation compartment (6).

9. The clutch activation system according to claim 8, wherein the starting clutch (1) is designed as a multidisc clutch and is installed in an automatic transmission.

10. The clutch activation system according to claim 8, wherein the pressure compensation compartment (6) has an outlet opening (8) in an area of a radial end.

11. The clutch activation system according to claim 8, wherein the outlet opening (8) is designed as a pressure aperture or a valve is installed therein.

12. The clutch activation system according to claim 8, wherein a level of filling of the pressure compensation compartment (6) with the pressure medium is adjustable by means of an off and on device.

13. The clutch activation system according to claim 12, wherein the off and on device includes at least one valve, which, in the conditions of normal driving is controllable by a control apparatus and enables or prevents the filling of the pressure compensation compartment (6).

14. The clutch activation system according to claim 1, wherein at least one wall of the pressure compensation compartment (6) is formed from a side of the piston (4), which is remote from the pressure chamber (5) of the piston/cylinder combination (2).
